(19) United States
(12) Patent Application Publication
(10) Pub. No.: US 2013/0060906 A1
(43) Pub. Date: Mar. 7, 2013

(54) Transmitting a Media Stream Over HTTP

(71) Applicant: Christian Gan, Winnipeg (CA)

(72) Inventor: Christian Gan, Winnipeg (CA)

(21) Appl. No.: 13/224,950

(22) Filed: Sep. 2, 2011

(51) Int. Cl. G06F 15/16

(52) U.S. Cl. 709/219

(57) ABSTRACT

A media stream is transmitted over HTTP from a server which accepts TCP connections to a client. The system generates for a session a plurality of dedicated tunnels through the network. The stream is encapsulated into a series of data blocks with a sequence number in the header. Each time a block is sent, the system selects from the available tunnels that which currently has the least pending sends. At the client the blocks are re-ordered in a re-ordering buffer into sequential order and used to generate the media stream. The buffer ignores any data blocks which are not received within a set time period. New tunnels are opened when the number of pending blocks at the one with the least number is greater than a set number, but only up to a set maximum and only after a set delay time from the last tunnel opening.

### BACKGROUND OF THE INVENTION

The media stream referred to herein is typically a video feed but can be provided by an audio feed or a combination or by other streams of data which need to be maintained in an ordered, timed stream to be regenerated and displayed or used at a receive location.

Firewalls provide network security for both home and businesses by denying or allowing network traffic based on a set of rules. These security rules provide protection for assets within the internal network from unauthorized or malicious access coming from outside of the firewall. The level of security applied to the firewall is configured by the user or business and is dependant on the internal policies that are used to develop the set of access rules and vary greatly from site to site. Since streaming media protocols such as SIP and RTP/RTCP depend on access to certain ports on the firewall to be open, more restrictive rules can block the use of such protocols over the network. Changing the rules specifically for these protocols can be a time consuming task especially for businesses where change requests require formal applications from the IT department. Some IT departments may deny these change requests altogether if they are not within the scope of the company's security policy since streaming protocols are often not considered well known. A well known protocol that is usually allowed in security policies is HTTP/HTTPS.

Encapsulating protocols with HTTP/HTTPS is a technique called tunnelling and is known to those in the art. The problem with using HTTP/HTTPS tunnelling for streaming live media is the nature of the underlying transport protocol which is TCP. TCP uses algorithms that provide reliable transport of packetized data and utilizes features such as sequencing, flow control and congestion control. These features are developed to improve the reliability of general network traffic but can be detrimental to live media. Backoff and retry mechanisms have timeouts that far exceed the necessary transmission times required for a smooth and natural live streaming session. For streaming live media, arrival time is just as critical as packet loss and often it is better to drop packets altogether if delay becomes too great.

### SUMMARY OF THE INVENTION

It is one object of the invention to provide a method of transmitting streaming media data over the well known HTTP and HTTPS protocols.

According to the invention there is provided a method for transmitting a media stream over HTTP or HTTPS protocol:
wherein there is provided a server which accepts TCP connections and transmits media data through a network using HTTP protocol to a client;
wherein there is provided a client which requests TCP connections and receives media data through the network from the server;
the method comprising:
generating for a streaming session a plurality of tunnels through the network each of which connects the server to the client for transmission of the streaming media data from the server to the client;
encapsulating the media stream over HTTP into a series of sequential data blocks containing media stream data, where each block includes a sequence number;
for each data block to be sent, selecting from the tunnels that one of the plurality of tunnels which currently has the least number of pending data blocks waiting to be sent;
receiving the data blocks through the tunnels at the client and, in a re-ordering buffer, re-ordering the received data blocks from the HTP tunnels into a sequential order using the sequence number;
and using media stream data from the sequential order of received data blocks to generate the media stream.

Preferably the re-ordering buffer is arranged to ignore any data blocks in the sequential order which are not received within a set time period. That is the re-ordering buffer is arranged to ignore any data blocks in the sequential order which are not received by a time of use of the data blocks to generate the media stream.

Preferably at least one new tunnel is opened when the number of pending data blocks waiting to be sent, at said one of the plurality of tunnels which currently has the least number of pending data blocks waiting to be sent, is greater than a set number. In order that new tunnels are not opened to numbers greater than can reasonable accommodated by the network, preferably the method includes negotiating between the client and the server for the streaming session a maximum number of tunnels that can be used within the streaming session so that the new tunnel is opened only if a total number of tunnels being used in the session including said at least one new tunnel is less than said maximum number. Also the new tunnel is opened only if a set time period has elapsed since a previous new tunnel was opened.

Preferably a request to the network for opening a new tunnel is generated by the client. The client or server generally determines when the number of pending data blocks waiting to be sent, at said one of the plurality of tunnels which currently has the least number of pending data blocks waiting to be sent, is greater than a set number. If the preceding condition is true, a client will immediately issue a request to open a new tunnel to the server. In the case of a server, the server will communicate the preceding condition to the client so that the client can issue a request to open a new tunnel.

Typically the tunnels are bi-directional between the server and the client.

It will be appreciated that the terms “server” and “client” as used herein are intended to merely refer to end points and are not intended to limit those defined elements as particular types of end point. Thus the arrangement described herein is explained as though the video is streamed from a server to a client. However the video signals can also be streamed in both directions as a bidirectional arrangement.

In practice, the system can be of the type described in U.S. Pat. No. 7,221,386 assigned to the present assignee, the disclosure of which is incorporated herein by reference or may be reviewed for further detail of the system. Thus the system is often arranged such that the streaming devices or server form a central hub containing the operating software communicating with a plurality of receiving clients running software on a remote terminal such as a PC or smartphone, all of which are all considered as ‘endpoints’. The system does not look at one as a client and the other as a server, as either end can originate and stream audio and/or video. Typically, the remote terminal is the source of live video but it does not always have to be. Thus the implementation actually typically consists of various endpoints with a server in the middle. Media streams can go from endpoint A to endpoint B, from endpoint B to endpoint A or bi-directionally between A and B.

With this arrangement as described herein, the HTTP to RTP media bridge is implemented via a server box located somewhere in the internet. As this is done to bridge firewalls the server will typically reside in the public internet, accessible to all. That is typically a network diagram of the system will include multiple endpoints across the network/internet with a server bridge located in the middle. The system is typically implemented with a server because of the previously mentioned firewall traversal issue but firewall traversal does not need to be a factor for this invention to have merit.

In some embodiments the media stream comprises a video stream requested by the client and transmitted by the server. That is the video is transmitted only in one direction as a result of a request. In other embodiments, the communication of video is in both directions so that the client also transmits a media stream to the server. This is done using a symmetrical arrangement or protocol, that is the above stated steps are carried out also in the direction of transmission from the client to the server. In this regard, the terms “client” and “server” as used herein are merely for convenience to define two different entities and is not intended to characterize the relationship between the two or between the entities and the network.

In one arrangement, the media stream comprises a video stream requested by the client and transmitted by the server and wherein there is provided a bidirectional communication of an audio media stream using a symmetrical protocol.

The encapsulated sequential data blocks each are defined by a plurality of packets of data sent separately.

Preferably each media data block is also time-stamped along with the sequence number.

Thus all data is encapsulated and conforms to the HTTP 1.1 specification, that is the version of HTTP currently in use, so that firewalls do not deny the traffic if the packets are inspected.

One of the motivations for this arrangement, which may be achieved, is to improve real-time performance of streaming media.

### BRIEF DESCRIPTION OF THE DRAWINGS

One embodiment of the invention will now be described in conjunction with the accompanying drawings in which:

FIG. 1 is a schematic illustration of the system according to the present invention.

In the drawings like characters of reference indicate corresponding parts in the different figures.

### DETAILED DESCRIPTION

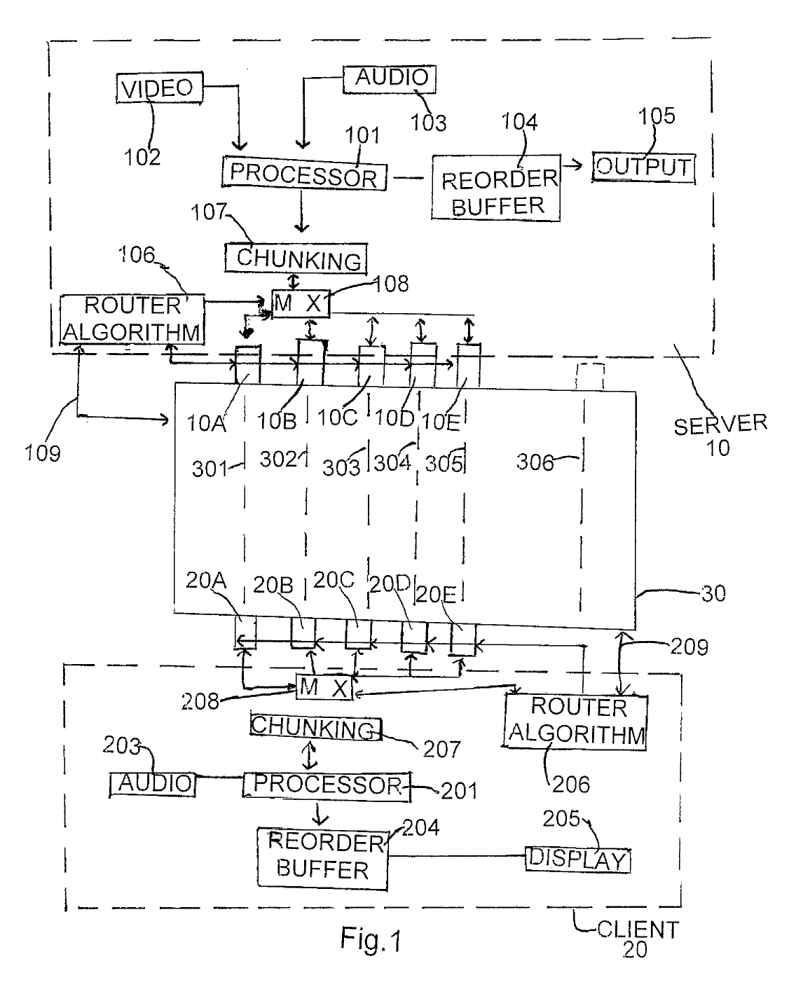

As shown schematically in FIG. 1 there is provided a method for transmitting a media stream over HTTP or HTTPS protocol between a server 10 and a client 20 through a network 30.

The server 10 includes a processor 101 which controls the operation and receives inputs from a video input 102 and an audio input 103. The processor controls output of received signals to a re-order buffer 104 which re-generates a signal for output to an output display or audio speaker 105. The processor controls supply of signals from the video and/or audio inputs to a chunking program 107 and from the chunking step 107 to a multiplexer 108. The multiplexer 108 is controlled by a program 106 which acts as a router algorithm for determining a selected one of a plurality of ports of tunnels 301 to 306 of the network 30. Each tunnel has associated with it a message queuing system 10A to 10E which acts to stack up messages or packets to be transmitted through the port.

Symmetrically the client 20 includes a processor 201 which controls the operation and receives inputs from an audio input 203. The processor 201 controls output of received signals to a re-order buffer 204 which re-generates a signal for output to an output display or audio speaker 205. The processor 201 controls supply of signals from the audio input 203 to a chunking program 207 and from the chunking step 207 to a multiplexer 208. The multiplexer 208 is controlled by a program 206 which acts as a router algorithm for determining a selected one of a plurality of ports of tunnels 301 to 306 of the network 30. Each tunnel has associated with it a message queuing system 20A to 20E which acts to stack up messages or packets to be transmitted through the port.

The server 10 is arranged to accept TCP connections and transmit media data which can be video and/or audio or can be of other streaming data, through the network 30 using HTTP protocol. In this arrangement the server is also capable of receiving streaming media data from the client but this is not essential and the system can operate in a one way mode.

The client 20 is arranged to request TCP connections and receives media data through the network from the server.

The method operates by initially generating for a streaming session a plurality of bi-directional tunnels 301 to 305 through the network each of which connects the server to the client for transmission of the streaming media data from the server to the client. Initially there may be only one tunnel 301 as more tunnels are added during the session including tunnels 301 to 305 and including another optional tunnel 306.

The number of tunnels may change depending on network architecture/conditions/etc. Is this just a specific example—6 tunnels? Additional tunnels can continue to be added up to the maximum (which could be a hard coded number or determined based on some other algorithm).

In the chunking program 107 the media stream is encapsulated over HTTP into a series of sequential data blocks containing media stream data, where each block includes a sequence number identifying its position in the series of blocks to be transmitted. The block may comprise a single audio or video frame to be transmitted using conventional transmission protocols or may include multiple frames depending on the amount of data to be transmitted.

The router algorithm 106 is arranged to detect from the available tunnels which have been established for the session, that one of the plurality of tunnels 301 to 305 which currently has the least number of pending data blocks in the queuing systems 1OA to 10E waiting to be sent. This is done by a round robin algorithm which looks at each queue in turn to determine the number of messages in line to be sent. It will be appreciated that the HTTP protocol uses the TCP protocol for transport which uses retries and repeated requests for lost messages and tends to delay transmissions with duplicate messages.

The multiplexer 108 is controlled by the program 106 to place the message to be sent in the queuing system of the tunnel which has been determined to have the fewest messages in line.

The round robin algorithm typically will note the tunnel on which the last message was added by the multiplexer and look initially at the next tunnel in turn and only if that has a large number of messages in line will move to the next. Thus tunnels with a large number of messages in line are ignored until the number becomes reduced over time as the messages are sent.

At the client, the data blocks received through the tunnels are communicated as they are received through the multiplexer 208 to the processor and are supplied to the re-ordering buffer 204 which operates to place the blocks in a row in a buffer with the blocks being re-ordered independently of their order of receipt into a sequence depending only on their applied sequence number.

The buffer 204 supplies the stream of sequential blocks in order as required to the display 205 where the media stream data from the sequential order of received data blocks is used to generate the media stream to form the image or audio track on the display 205.

The re-ordering buffer is arranged to ignore any data blocks in the sequential order which are not received within a set time period. That is the re-ordering buffer is arranged to ignore any data blocks in the sequential order which are not received by a time of use of the data blocks to generate the media stream.

The algorithm 106 is used to monitor the number of messages waiting to be sent. The intention is that when the total delay becomes too great a new tunnel is opened. This is done by monitoring when the number of pending data blocks waiting to be sent at that one of the plurality of tunnels which currently has the least number of pending data blocks, is greater than a set number. In order that new tunnels are not opened to numbers greater than can reasonable accommodated by the network, the method includes negotiating between the client and the server by separate communications 209 and 109 through the network for the streaming session a maximum number of tunnels that can be used within the streaming session. Thus the new tunnel requested by the client is opened only if the total number of tunnels being used in the session including said at least one new tunnel is less than said maximum number. Also the new tunnel is opened only if a set time period has elapsed since a previous new tunnel was opened.

The encapsulated sequential data blocks each are defined by a plurality of packets of data sent separately.

Preferably each media data block is also time-stamped by the chunking system 107 along with the applied sequence number.

Thus all data is encapsulated and conforms to the HTTP 1.1 specification, that is the version of HTTP currently in use, so that firewalls do not deny the traffic if the packets are inspected.

The chunking program 107, 207 otherwise known as “chunked transfer encoding” of HTTP 1.1 is described in the RFC 2616: Hypertext Transfer Protocol—HTTP/1.1 (Section 3.6.1) and used to continuously transmit binary media data over the HTTP protocol within a single HTTP request/response.

At the beginning of a session, the server and client negotiate the maximum number of HTTP tunnels (TMax) that can be used per media session. This value is configurable on the server location.

Initially both the client and server start with one HTTP tunnel and increase this number during the session as required depending on the following requirements so that, at any one time there are n HTTP client tunnels and n HTTP server tunnels.

During transmission, the client places a media data block on the send queue of that one of the HTTP client tunnels which currently has the least amount of blocks pending to be sent. The client determines which client tunnel to use for transmission by searching for the least utilized HTTP tunnel. The least utilized HTTP tunnel is the tunnel which has the fewest amount of pending sends. The HTTP tunnel(s) with current pending sends are likely to have been backlogged by TCP backoff/retry algorithms which are an essential component of the HTTP or HTTPS protocol.

Even though the pending data blocks will eventually get sent by the TCP retries, they will likely arrive too late on the remote endpoint for live media streaming. Therefore it is preferable that backlogged tunnels not be used for transmission until the pending sends clear the TCP transport layer.

Each media data block put on a HTTP tunnel is time-stamped and identified by an incrementing sequence number that is global within the scope of the media session.

The client may request a new HTTP tunnel from the server provided that:
a) The number of pending sends on the least utilized HTTP tunnel is greater than a configurable value SMax;
b) It has been tnt milliseconds (where tnt is a configurable value) since the last request issued by the client for a new HTTP tunnel; and
c) The number of current HTTP tunnels is less than the maximum number of tunnels negotiated for the session (TMax).

When the server receives a request from the client for a new HTTP tunnel, it will accept the connection provided that the number of current HTTP tunnels is less than the maximum number of tunnels negotiated for the session (TMax).

Even though packets may be lost or dropped in transmission, it is vital in streaming media for media data to be processed in chronological order so that video or audio does not skip backwards in time. Therefore it is necessary for media data blocks received from multiple HTTP tunnels to be re-ordered when they arrive. When a media block arrives from an HTTP tunnel, it is passed to the re-order buffer which will insert the packet in a sorted queue depending on the data block's sequence number. If a data block is missing at the top of the queue, the re-order buffer 204 will wait tro milliseconds (where tro is a configurable value) for the late or out-of-order data block to arrive. if the data block does not arrive within tro milliseconds, the re-order buffer will consider the data block lost or too late and move to the next data block in sequence. All data blocks that have arrived and are in sequence will be passed onto the video or audio consumer.

The number of tunnels, the maximum allowable number of tunnels, the value Smax, the value tnt and the value tro are all determined based on analysis of the system concerned and the media data to be transmitted. In most case these can be predetermined by analysis of systems so that they can be set up in advance as options within the system and selected by the system depending on the characteristics of the media data, the server and the client.

1. A method for transmitting a media stream over HTTP or HTTPS protocol:
wherein there is provided a server which accepts TCP connections and transmits media data through a network using HTTP protocol to a client;
wherein there is provided a client which requests TCP connections and receives media data through the network from the server;
the method comprising:
generating for a streaming session a plurality of tunnels through the network each of which connects the server to the client for transmission of the streaming media data from the server to the client;
encapsulating the media stream over HTTP into a series of sequential data blocks containing media stream data, where each block includes a sequence number;
for each data block to be sent, selecting from the tunnels that one of the plurality of tunnels which currently has the least number of pending data blocks waiting to be sent;
receiving the data blocks through the tunnels at the client and, in a re-ordering buffer, re-ordering the received data blocks from the HTP tunnels into a sequential order using the sequence number;
and using media stream data from the sequential order of received data blocks to generate the media stream.

2. The method according to claim 1 wherein the re-ordering buffer is arranged to ignore any data blocks in the sequential order which are not received within a set time period.

3. The method according to claim 1 wherein the re-ordering buffer is arranged to ignore any data blocks in the sequential order which are not received by a time of use of the data blocks to generate the media stream.

4. The method according to claim 1 wherein at least one new tunnel is opened when the number of pending data blocks waiting to be sent, at said one of the plurality of tunnels which currently has the least number of pending data blocks waiting to be sent, is greater than a set number.

5. The method according to claim 4 including negotiating between the client and the server for the streaming session a maximum number of tunnels that can be used within the streaming session and wherein said at least one new tunnel is opened only if a total number of tunnels being used in the session including said at least one new tunnel is less than said maximum number.

6. The method according to claim 4 wherein said at least one new tunnel is opened only if a set time period has elapsed since a previous new tunnel was opened.

7. The method according to claim 4 wherein a request for opening said at least one new tunnel is generated by the client.

8. The method according to claim 4 wherein the server determines when the number of pending data blocks waiting to be sent, at said one of the plurality of tunnels which currently has the least number of pending data blocks waiting to be sent, is greater than a set number.

9. The method according to claim 1 wherein the tunnels are bi-directional between the server and the client.

10. The method according to claim 1 wherein the media stream comprises a video stream requested by the client and transmitted by the server.

11. The method according to claim 1 wherein the client transmits a media stream to the server using a symmetrical protocol.

12. The method according to claim 1 wherein the media stream comprises a video stream requested by the client and transmitted by the server and wherein there is provided a bidirectional communication of an audio media stream using a symmetrical protocol.

13. The method according to claim 1 wherein the encapsulated sequential data blocks conform to the HTTP specification so that firewalls do not deny the traffic if the data blocks are inspected.

14. The method according to claim 1 wherein the encapsulated sequential data blocks each are defined by a plurality of packets of data sent separately.

15. The method according to claim 1 wherein each media data block is time-stamped.
